(19) United States
(12) Patent Application Publication
(10) Pub. No.: US 2020/0262735 A1
(43) Pub. Date: Aug. 20, 2020

(54) METHOD FOR PRODUCING GLASS PARTICULATE DEPOSIT, METHOD FOR PRODUCING GLASS PREFORM, AND GLASS PREFORM

(71) Applicant: SUMITOMO ELECTRIC INDUSTRIES, LTD., Osaka-shi, Osaka (JP)

(72) Inventors: Masatoshi HAYAKAWA, Osaka-shi, Osaka (JP); Masumi ITO, Osaka-shi, Osaka (JP)

(73) Assignee: SUMITOMO ELECTRIC INDUSTRIES, LTD., Osaka-shi, Osaka (JP)

(21) Appl. No.: 16/642,571

(22) PCT Filed: Aug. 28, 2018
(86) PCT No.: PCT/JP2018/031695

§ 371 Date: Feb. 27, 2020

(30) Foreign Application Priority Data
Aug. 29, 2017 (JP) 2017-164239

(51) Int. Cl. C03B 37/018

(52) U.S. Cl. CPC C03B 37/018; C03B 2207/66; C03B 2207/70

(57) ABSTRACT

Provided is a method for producing a glass particulate deposit, the method including disposing at least one burner at a position facing a rod that rotates around an axis, and spraying glass particulates generated in the flame from the burner to the rod while relatively reciprocating the rod and the burner in the axis direction of the rod, to deposit glass particulates, wherein the relation of 0.1 W≤V/R≤1.0 W is satisfied, where W mm represents the luminance width of the flame of the glass raw material, R rotations/min represents the rotational speed of the rod, and V mm/min represents the speed of the reciprocation.

### TECHNICAL FIELD

The present disclosure relates to a method for producing a glass particulate deposit, a method for producing a glass preform, and a glass preform.

This present application claims priority based on Japanese Patent Application No. 2017-164239 filed on Aug. 29, 2017, the contents of which are incorporated herein by reference in its entirety.

### BACKGROUND ART

The vapor phase synthesis method, in which a rotating starting rod and a burner arranged to face the starting rod are relatively reciprocated (traversed), and glass particulates generated by the burner are sprayed to a surface of the starting rod to be deposited in a layered manner, is known. A method for producing a glass particulate deposit by the vapor phase synthesis method is disclosed in the following related art documents.

Patent Literature 1 discloses that when the relative reciprocating movement between the rod and the burner performs one reciprocation and returns to the original position, the reciprocating movement speed and the rotation speed of the rod are adjusted in accordance with a reciprocating movement distance of one reciprocation so that the rotational position of the rod is shifted from the original position by a half cycle.

Patent Literature 2 discloses that a value represented by A=(r/v)×L₀ is set so as to be in a range of 40≥A≥8 when a plurality of burners are disposed at equal intervals, and the reciprocating movement speed v mm/min, rotation speed r rotations/min, and burner interval set value L₀ mm of the rod are used as parameters.

### CITATION LIST

### Patent Literature

Patent Literature 1: JP2013-043810

Patent Literature 2: JP2002-167228

### SUMMARY OF INVENTION

A method for producing a glass particulate deposit according to the present disclosure is provided, which

disposes at least one burner at a position facing a rod that rotates around the axis, and sprays glass particulates generated in a flame from the burner to the rod while relatively reciprocating the rod and the burner in an axis direction of the rod, to deposit the glass particulates,

in which a relation of 0.1 W≤V/R≤1.0 W is satisfied, where W mm represents a luminance width of a flame of glass raw material, R rotations/min represents a rotational speed of the rod, and V mm/min represents a speed of the reciprocation.

In addition, a method for producing a glass preform according to the present disclosure is provided, which includes a transparentizing process of producing a glass particulate deposit by the method for producing a glass particulate deposit described above, and heating the produced glass particulate deposit to produce a transparent glass preform.

Further, a glass preform according to the present disclosure is provided, which has a variation rate of an outer diameter of 5% or less in a longitudinal direction.

### BRIEF DESCRIPTION OF DRAWINGS

FIG. 1 is a configuration diagram showing an embodiment of a producing apparatus that performs a method for producing a glass particulate deposit according to an embodiment of the present disclosure.

FIG. 2 is a diagram schematically showing a method for producing a glass particulate deposit according to an embodiment of the present disclosure.

FIG. 3 is a diagram schematically showing a flame radiated from a burner in a method for producing a glass particulate deposit according to an embodiment of the present disclosure.

FIG. 4 is a diagram showing an example of binarizing the luminance of the flame shown in FIG. 3.

FIG. 5A is a diagram schematically showing a state of deposition of the glass particulates on a rod when V/R>W.

FIG. 5B is a diagram schematically showing a state of deposition of the glass particulates on a rod when V/R=W.

FIG. 5C is a diagram schematically showing a state of deposition of the glass particulates on a rod when V/R<W.

FIG. 6A is a schematic diagram showing a finally produced glass particulate deposit, which has a shape in which an outer diameter varies in a longitudinal direction.

FIG. 6B is a schematic diagram showing a finally produced glass particulate deposit, which has a shape in which the outer diameter does not vary in the longitudinal direction.

### DESCRIPTION OF EMBODIMENTS

### Problem to be Solved by the Present Disclosure

However, it is desired to further suppress the variation in the outer diameter of the glass particulate deposit in the longitudinal direction than the techniques of Patent Literatures 1 and 2.

Therefore, an object of the present disclosure is to provide a method for producing a glass particulate deposit having a smaller variation in the outer diameter in the longitudinal direction than the related art, a method for producing a glass preform, and a glass preform.

### Effect of the Present Disclosure

According to the present disclosure, it is possible to produce a glass particulate deposit having a small variation in the outer diameter in the longitudinal direction.

### Description of Embodiments of the Present Disclosure

First, the contents of the embodiments of the present disclosure will be listed and described.

Note that the present disclosure is not limited to these exemplifications, but is indicated by the claims, and includes all modifications within the scope and meaning equivalent to the scope of the claims.

A method for producing a glass particulate deposit according to an aspect of the present disclosure is

(1) a method for producing a glass particulate deposit, which disposes at least one burner at a position facing a rod that rotates around the axis; and sprays glass particulates generated in a flame from the burner to the rod while relatively reciprocating the rod and the burner in an axis direction of the rod, to deposit the glass particulates, and

in which a relation of 0.1 W≤V/R≤1.0 W is satisfied, where W mm represents a luminance width of a flame of glass raw material, R rotations/min represents a rotational speed of the rod, and V mm/min represents a speed of the reciprocation.

With this configuration, it is possible to produce a glass particulate deposit having a small variation in the outer diameter in the longitudinal direction.

(2) It is preferable that a relation of 0.1 W≤V/R≤0.5 W is satisfied, where W represents the luminance width, R represents the rotational speed, and V mm/min represents the speed of the reciprocation.

With this configuration, it is possible to produce a glass particulate deposit having a small variation in the outer diameter in the longitudinal direction.

(3) It is preferable to use siloxane as the glass raw material.

With this configuration, the raw material used does not contain corrosive halogen, so that the problem of corrosion of the producing apparatus or the like due to the exhaust gas and the exhaust gas treatment equipment can be eliminated. Further, since siloxane has high combustibility, the production efficiency of the glass particulate deposit can be increased.

(4) It is preferable to use octamethylcyclotetrasiloxane (OMCTS) as the siloxane.

With this configuration, the raw materials used can be easily obtained industrially, and allow ease of storage and handling.

(5) In addition, the method for producing a glass preform according to an aspect of the present disclosure includes a transparentizing process of producing a glass particulate deposit by the method for producing a glass particulate deposit of any one of (1) to (4), and heating the produced glass particulate deposit to produce a transparent glass preform.

With this configuration, a high-quality glass preform can be produced.

(6) The glass preform according to an aspect of the present disclosure has a variation rate of an outer diameter of 5% or less in a longitudinal direction.

With this configuration, when the glass preform is used for producing an optical fiber, it is possible to produce an optical fiber with little variation in optical characteristics in the longitudinal direction.

(7) Further, it is preferable that the variation rate of the outer diameter in the longitudinal direction is 1.5% or less.

With this configuration, it is possible to produce an optical fiber having a smaller variation in the optical characteristics in the longitudinal direction.

### Details of Embodiments of the Present Disclosure

### Outline of Producing Method and Equipment Used, Etc

Hereinafter, an example of an embodiment of a method for producing a glass particulate deposit (hereinafter, also simply referred to as a “deposit”) and a method for producing a glass preform according to an embodiment of the present disclosure will be described with reference to the accompanying drawings. In the drawings, the gas supply device for the flame forming gas is omitted, and the description in the text is also omitted.

Further, as a producing method described below, Outside Vapor Deposition (OVD) method will be described as an example, but the present disclosure is not limited to the OVD method. In addition to the OVD method, the present disclosure may be applied to a method of depositing glass from a glass raw material using a flame pyrolysis reaction such as, for example, a Multiburner Multilayer Deposition (MMD) method and the like that uses a plurality of burners.

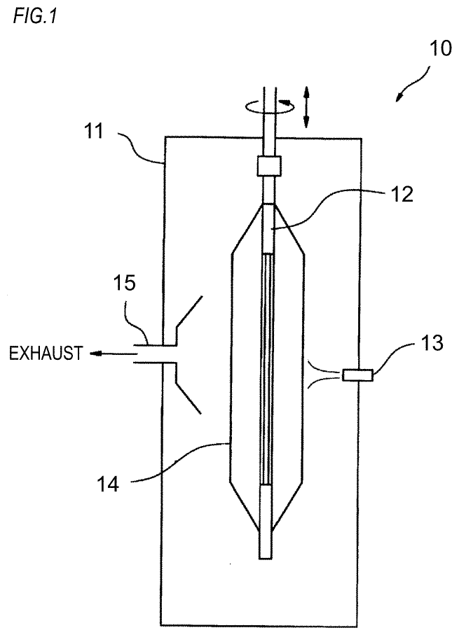

As shown in FIG. 1, a producing apparatus 10 is an apparatus that produces a deposit 14 serving as a preform of an optical fiber preform by depositing glass particulates generated in a flame of a burner 13 on a rod 12 in a reaction vessel 11. The burner 13 is disposed to face the rod 12, and an exhaust path 15 is provided on the opposite side to the burner 13 in the reaction vessel 11. The producing apparatus 10 produces the deposit 14 by a method in which the rod 12 is reciprocated (traversed) in the axis direction, so that the rotating rod 12 and the burner 13 are reciprocated relatively in the axis direction of the rod 12 and glass particulates are deposited on the surface of the rod 12 in a layered manner.

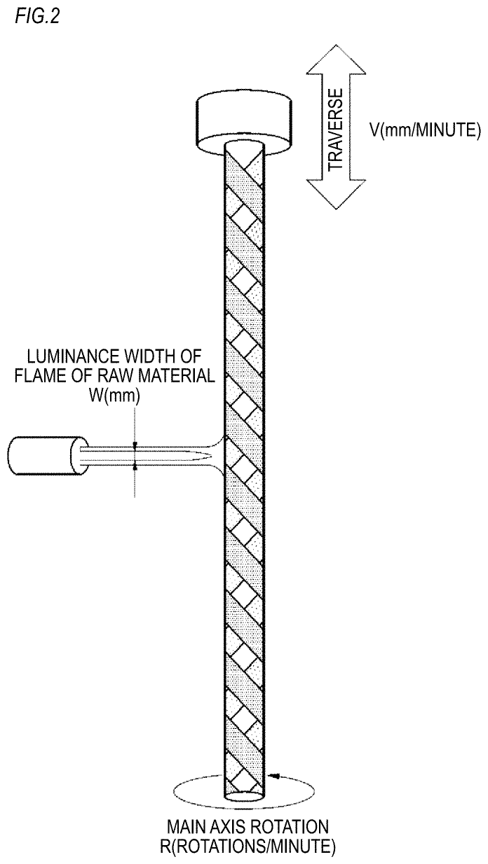

More specifically, as shown in FIG. 2, the glass particulates are deposited on an outer periphery of the rod 12 in a width of a glass raw material flame (hereinafter, also simply referred to as “raw material flame”) radiated from the burner. At this time, the layer of the glass particulates is formed in a band shape and formed spirally on the outer periphery of the rod 12 by the axial movement and rotation of the rod 12. Then, the rod 12 is reciprocated in the axis direction a plurality of times until the glass particulate deposition layer has a desired thickness.

Here, R rotations/min represents the rotation speed of the rod, and V mm/min represents the reciprocating speed. V/R is equivalent to the axial movement distance during one rotation of the rod 12.

The flame radiated from the burner 13 will be described.

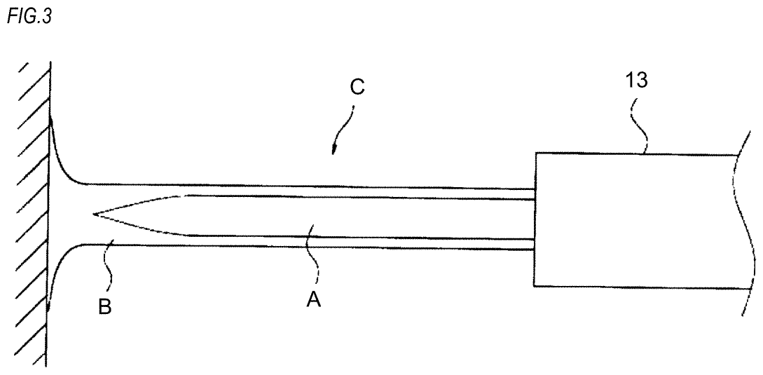

The flame radiated from the burner 13 is schematically shown in FIG. 3. As shown in FIG. 3, a flame C radiated from the burner 13 is divided into a raw material flame A at the center and a flame B outside the flame. Note that the raw material flame A at the center has a higher luminance than the flame B, and this is because the raw material flame A burns the raw material and has a higher luminance than the peripheral part.

In addition, in the raw material flame A, glass particulates are formed by burning the glass raw material, and the glass particulates are deposited on the outer periphery of the rod 12 as the particulates are sprayed to the rod 12.

There is no particular limitation on the glass raw material that is put into the flame and forms the raw material flame A, as long as it can generate glass particulates by the flame decomposition reaction or the oxidation reaction in the embodiment described above. Examples include silicon tetrachloride (SiCl₄), siloxane, and the like. Among these, siloxane is preferable in that it does not generate corrosive gas such as chlorine and has high combustibility as compared with SiCl₄, so that the production efficiency of the glass particulate deposit may be increased. Further, among siloxanes, cyclic siloxanes are preferred from the viewpoint of industrial availability and ease of storage and handling, and among these, octamethylcyclotetrasiloxane (OMCTS) is more preferable.

The gas for generating the flame is not particularly limited as long as the flame for generating glass particulates from the glass raw material can be formed by the burner. In general, hydrogen (H₂) as a combustible gas, and oxygen (O₂), nitrogen (N₂), and the like as a combustion supporting gas can be appropriately mixed and used. In this case, it is preferable that hydrogen, oxygen, and nitrogen are ejected from separate ejection ports, respectively, and mixed after the ejection.

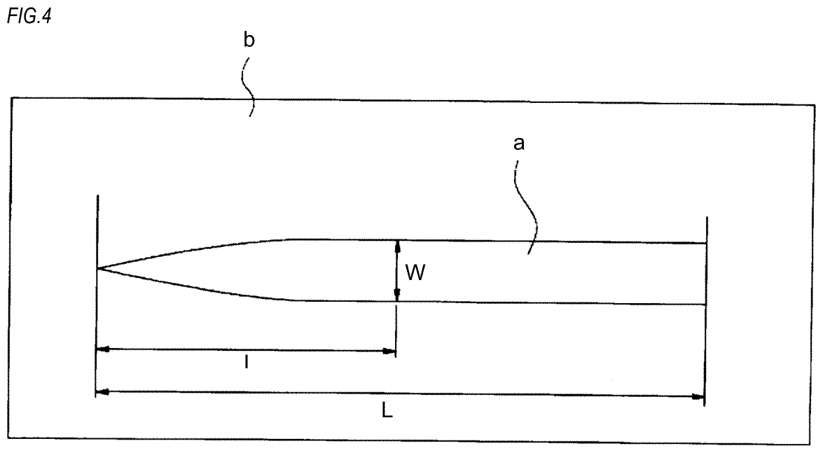

The width of the raw material flame A may be measured by measuring the luminance distribution (L(x, y)) of the flame C radiated from the burner 13, normalizing the measured luminance distribution (L(x, y)) with the maximum luminance Lmax, and, for example, binarizing the measured luminance distribution (L(x, y)) based on whether or not the portion satisfies L(x, y)/Lmax≥0.8. FIG. 4 shows an example of the binarized result. In FIG. 4, a region a corresponds to L(x, y)/Lmax≥0.8, and a region b corresponds to L(x, y)/Lmax<0.8. In this case, the region a in FIG. 4 corresponds to the raw material flame A in FIG. 3. Then, the entire length of the region a in FIG. 4 in the length direction (corresponding to a length from the flame radiation port of the burner 13 to a tip end of the raw material flame A in FIG. 3) is defined as L, and the width of the region a at the midpoint of L (corresponding to a position at a distance 1 of 50% of L from the tip end of the region a) is defined as the luminance width W of the raw material flame A.

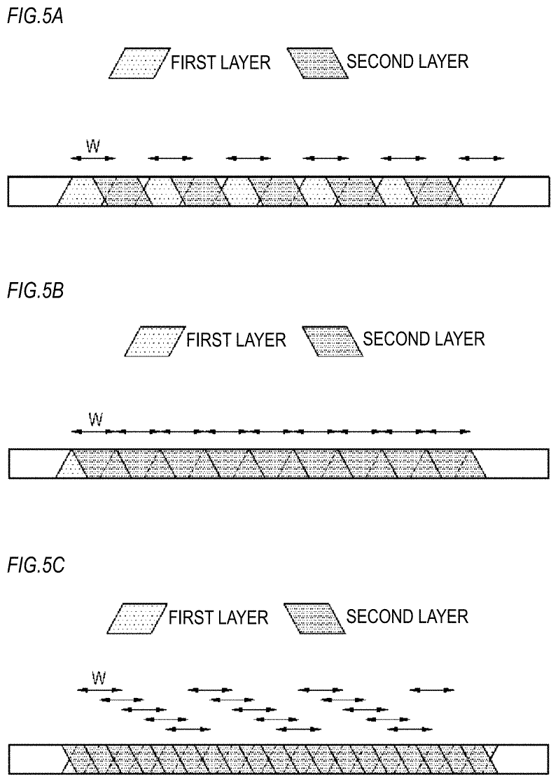

FIGS. 5A, 5B, and SC schematically show the state of deposition of the glass particulates on the rod 12 in each of the case when V/R is greater than W (V/R>W), of the case when V/R is equal to W (V/R=W), and of the case when V/R is smaller than W (V/R<W). In this case, for the purpose of simplifying the description and the understanding thereof, the case in which the reciprocating movement of the rod 12 is performed only once in the producing apparatus 10 in FIG. 1 that has only one burner 13 will be described.

FIG. 5A shows the state of deposition of the glass particulates when V/R>W.

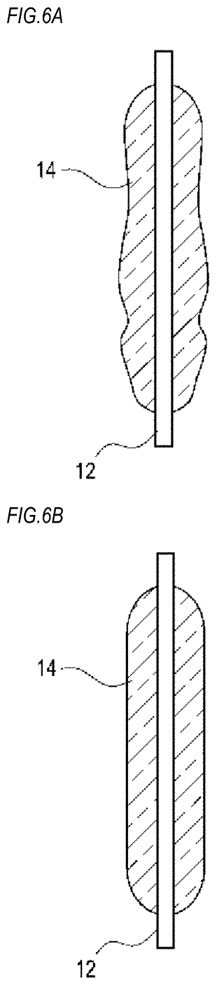

Although the glass particulates are formed on the outer periphery of the rod 12 in a spiral band shape, for example, there occurs a gap portion where the glass particulates are not deposited, between the glass particulates in the deposited portion formed in the first round and the glass particulates in the deposited portion formed in the second round. In this case, when the reciprocating movement of the rod 12 is repeated many times and the glass particulate deposition layer is thickened, a deposit is formed, in which an outer diameter is varied in the longitudinal direction as shown in FIG. 6A.

FIG. 5B shows the state of deposition of the glass particulates when V/R=W. Although the glass particulates are formed on the outer periphery of the rod 12 in a spiral band shape, for example, there is no gap between the deposited portion formed in the first round and the deposited portion formed in the second round. In this case, when the reciprocating movement of the rod 12 is repeated many times and the glass particulate deposition layer is thickened, a deposit is formed, in which the outer diameter does not vary in the longitudinal direction as shown in FIG. 6B.

FIG. 5C shows the state of deposition of the glass particulates when V/R<W. Although the glass particulates are formed on the outer periphery of the rod 12 in a spiral band shape, for example, the deposited portion formed in the first round and the deposited portion formed in the second round partially overlap each other and there is no gap. Also in this case, when the reciprocating movement of the rod 12 is repeated many times and the glass particulate deposition layer is thickened, a deposit is formed, in which the outer diameter does not vary in the longitudinal direction as shown in FIG. 6B.

Table 1 below shows the variation rate of outer diameter of the deposit 14 in the longitudinal direction when the V/R is in the range of 0.05 W to 1.40 W. The reciprocating movement of the rod 12 was performed 400 times, and the variation in the outer diameter was calculated by the following equation.

Variation in outer diameter [%]=(maximum variation in outer diameter/average outer diameter)×100

TABLE 1

| | Variation rate of |
|---|---|
| V/R | outer diameter [%] |
| 0.05 W | 1.12 |
| 0.10 W | 1.17 |
| 0.30 W | 1.25 |
| 0.50 W | 1.29 |
| 0.70 W | 2.45 |
| 0.90 W | 2.89 |
| 1.00 W | 4.68 |
| 1.20 W | 8.29 |
| 1.40 W | 12.35 |

From the results in Table 1 above, it can be seen that the smaller the V/R is, the smaller the variation is in the outer diameter of the deposit 14 in the longitudinal direction.

However, when the V/R is extremely small, the glass particulates are deposited in a ball shape and the stress balance of the deposit 14 is uneven, and even during the deposition process, there is a high possibility of damage due to unexpected small impacts, or the like.

Considering the above comprehensively, it was found that when the V/R is in the range of 0.1 W to 1.0 W, a good deposit 14 having a small variation in the outer diameter in the longitudinal direction may be produced.

Therefore, in the present embodiment, in the process of depositing the glass particulates on the rod 12, the relation of 0.1 W≤V/R≤1.0 W is satisfied, where W mm represents the luminance width of the raw material flame radiated from the burner 13, R rotations/min represents the rotational speed of the rod 12, and V mm/min represents the speed of the reciprocation of the rod 12.

This is more preferable because, when V/R is in the range of 0.1 W to 0.5 W, the variation in the outer diameter is further reduced.

[Transparentizing Process]

The glass particulate deposit 14 obtained by the producing method described above was heated to 1100° C. in a mixed atmosphere of an inert gas and chlorine gas, and then heated to 1550° C. in a He atmosphere to obtain a transparent glass preform.

In addition, when the bulk density is uniform in the longitudinal direction, the variation rate of the outer diameter of the glass preform is substantially equal to the variation rate of the outer diameter of the glass particulate deposit. Therefore, the variation rate of the outer diameter of the glass preform obtained by consolidating the glass particulate deposit produced while varying the V/R as shown in Table 1 is substantially equal to the variation rate of the outer diameter shown in Table 1.

When the outer diameter of the glass preform varies in the longitudinal direction, the optical characteristics also vary at substantially the same rate. In order for the optical characteristics to be within the specification over the entire length in the longitudinal direction, it is preferable to suppress the variation in the optical characteristics to 5% or less, and more preferable to suppress the variation to 1.5% or less.

Therefore, as described above, when V/R is in the range of 0.1 W to 1.0 W, the optical characteristics in the longitudinal direction can be suppressed to 5% or less, and when the V/R is in the range of 0.1 W to 0.5 W, the optical characteristics in the longitudinal direction can be suppressed to 1.5% or less, thereby producing an optical fiber having excellent optical characteristics.

Note that, in the embodiment described above, although the glass raw material that is liquid is ejected from the burner 13 in a gas state, the glass raw material may be ejected from the burner 13 in a liquid spray state rather than being in the gas state. In an aspect in which the glass raw material is ejected from the burner 13 in the liquid spray state, the liquid raw material ejected from a liquid raw material port (not shown) of the burner 13 is atomized by applying a gas ejected from an ejection gas port (not shown). Examples of the gas ejected from the ejection gas port include nitrogen (N₂), oxygen (O₂), argon (Ar), and the like, and these are ejected alone or in combination.

### REFERENCE SIGNS LIST

10: producing apparatus
11: reaction vessel
12: rod
13: burner
14: glass particulate deposit
15: exhaust path

1. A method for producing a glass particulate deposit, comprising:
disposing at least one burner at a position facing a rod that rotates around the axis; and
spraying glass particulates generated in a flame from the burner to the rod while relatively reciprocating the rod and the burner in an axis direction of the rod, to deposit the glass particulates,
wherein a relation of 0.1 W≤V/R≤1.0 W is satisfied, where W mm represents a luminance width of a flame of glass raw material, R rotations/min represents a rotational speed of the rod, and V mm/min represents a speed of the reciprocation.

2. The method for producing a glass particulate deposit according to claim 1, wherein a relation of 0.1 W≤V/R≤0.5 W is satisfied, where W represents the luminance width, R represents the rotational speed, and V represents the speed of the reciprocation.

3. The method for producing a glass particulate deposit according to claim 1, wherein siloxane is used as the glass raw material.

4. The method for producing a glass particulate deposit according to claim 3, wherein octamethylcyclotetrasiloxane (OMCTS) is used as the siloxane.

5. A method for producing a glass preform comprising:
a transparentizing process of producing a glass particulate deposit by the method for producing a glass particulate deposit according to claim 1, and heating the produced glass particulate deposit to produce a transparent glass preform.

6. A glass preform having a variation rate of an outer diameter of 5% or less in a longitudinal direction.

7. The glass preform according to claim 6, wherein the variation rate of the outer diameter in the longitudinal direction is 1.5% or less.
